(19) United States
(12) Patent Application Publication
(10) Pub. No.: US 2019/0317440 A1
(43) Pub. Date: Oct. 17, 2019

(54) IMAGE FORMING APPARATUS AND IMAGE FORMING CONTROL METHOD

(71) Applicant: Konica Minolta, Inc., Tokyo (JP)

(72) Inventors: Yasuo SHIOKAWA, Tokyo (JP); Yoshiteru KAWAKAMI, Tokyo (JP); Takahiro OKUBO, Yokohama-shi (JP)

(73) Assignee: Konica Minolta, Inc., Tokyo (JP)

(21) Appl. No.: 16/376,602

(22) Filed: Apr. 5, 2019

(30) Foreign Application Priority Data
Apr. 16, 2018 (JP) 2018-078380

(51) Int. Cl. G03G 15/00

(52) U.S. Cl. CPC G03G 15/5029; G03G 15/6561; G03G 15/6579

(57) ABSTRACT

Disclosed is an image forming apparatus, which may include: an image forming part that may form an image on a sheet; a sheet conveying part that may convey the sheet to the image forming part; a sheet length measuring part that may measure a length of the sheet on the basis of a passing timing of a tip end and a rear end of the sheet conveyed to a sheet conveying path; and a hardware processor that may perform control of aligning a formation position in a sheet conveying direction of the image between a first surface and a second surface of the sheet on the basis of a measurement result by the sheet length measuring part.

### CROSS REFERENCE TO RELATED APPLICATIONS

This application claims priority to Japanese Patent Application No. 2018-078380, filed on Apr. 16, 2018, which is incorporated herein by reference in its entirety.

### BACKGROUND

### Technological Field

The present disclosure relates to an image forming apparatus and an image forming control method.

### Description of the Related Art

Conventionally, there have been known image forming apparatuses that form an image on a sheet using toner. Some of such image forming apparatuses include a reverse conveying path included in a conveying path in which the front and rear of a sheet conveying direction is reversed in a switch-back manner (that is, backward moving) to reverse the front and back of the sheet in order to reverse the front and back of the sheet so that toner images can be printed on both surfaces.

For example, JP 2007-161427 A discloses a technology of, in consideration of a phenomenon in which the sizes of sheets and images are slightly changed in the image fixing process, reading the size of an image on a first surface of the sheet in which the image is formed by an image sensor, and reflecting the result in the magnification of the image to be printed on a second surface.

In recent years, users' requests for printed images have been further increased. In particular, there is a growing demand for aligning positions of toner images formed on a front surface (first surface) and a back surface (second surface) of a sheet during duplex printing. Such a demand arises, for example, when post-processing is performed such as performing duplex printing on a plurality of sheets and folding these sheets by center folding to bind into a book, or appropriately cutting margin portions to bind into a book.

In response to this demand, as a technology for correcting an image formation position in a main scanning side (width direction of a sheet), there is registration swinging control, that is, a technology of swinging a sheet in a width direction with a registration roller to correct an image formation position in the main scanning direction.

On the other hand, there is no effective technology of correcting an image formation position in a sub scanning direction (sheet conveying direction) at present. In particular, in the case of a method in which sheet is conveyed in a switch-back manner at the time of duplex printing as described above to perform registration in both ends of a conveying direction of the sheet, due to influence by the outer shape of both ends in the sheet conveying direction, it is not easy to accurately align a formation position of a toner image in the conveying direction.

Further, recently, there has been an increasing demand for duplex printing on a sheet called long sheet in which the size in the conveying direction is long. In such a long sheet, as the length of the sheet becomes longer, the variation in the length at the time of manufacturing tends to become larger, so that it is difficult to accurately align formation positions of toner images in a sheet conveying direction between the first surface and the second surface at the time of duplex printing.

In addition, as described above, the size of the sheet and image may vary due to the execution of the fixing process, and as the sheet length becomes longer, the change amount in such size may be larger. Therefore, at the time of duplex printing on a long sheet, it is further difficult to accurately align formation positions of toner images on the sheet in the conveying direction between the first surface and the second surface.

Regarding this point, JP 2007-161427 A discloses a technology of measuring the length of a sheet using an image sensor, and a configuration in which information on a surface of a sheet is repeatedly read out by image sensors (261, 262, 263) so that the length of a sheet is accurately measured. However, with such a configuration, it is disadvantageous in terms of productivity, cost, or the like of printing at the time of execution of a job of duplex printing on a long sheet or a job of conveying a plurality of sheets consecutively to perform duplex printing.

### SUMMARY

An object of the present disclosure is to provide an image forming apparatus and an image forming control method capable of securing productivity in duplex printing and capable of aligning image formation positions in a conveying direction between a first surface and a second surface of a sheet.

To achieve the abovementioned object, according to an aspect of the present disclosure, an image forming apparatus reflecting one aspect of the present disclosure comprises: an image forming part that forms an image on a sheet; a sheet conveying part that conveys the sheet to the image forming part; a sheet length measuring part that measures a length of the sheet on the basis of a passing timing of a tip end and a rear end of the sheet conveyed to a sheet conveying path; and a hardware processor that performs control of aligning a formation position in a sheet conveying direction of the image between a first surface and a second surface of the sheet on the basis of a measurement result by the sheet length measuring part.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the present invention:

FIG. 1 is a configuration diagram showing an example of an image forming apparatus according to an embodiment;

FIG. 2 is a diagram showing a main part of a control system in the image forming apparatus in FIG. 1;

FIGS. 3A and 3B are diagrams for explaining a problem in a case of performing duplex printing in a conventional image forming apparatus;

FIGS. 4A and 4B are diagrams for explaining a problem in a case of performing duplex printing in a conventional image forming apparatus, and illustrating printing results in a case where the length of a sheet is longer than that in the examples in FIGS. 3A and 3B;

FIG. 5 is a plan view exaggerating the error of the length of a sheet for each lot in a long sheet;

FIGS. 6A and 6B are diagrams showing an arrangement example of a conveyance sensor for measuring the length of a sheet;

FIGS. 7A to 7C are diagrams illustrating printing results in a case of performing duplex printing in the image forming apparatus according to the present embodiment;

FIG. 8A shows printing results of a first surface when a sheet has a reference length;

FIG. 8B shows printing results of the first surface of a sheet having a difference with respect to the reference length; and

FIG. 9 is a flowchart related to image formation control at the time of execution of a duplex printing job.

### DETAILED DESCRIPTION OF EMBODIMENTS

Hereinafter, one or more embodiments of the present disclosure will be described with reference to the drawings. However, the scope of the invention is not limited to the disclosed embodiments.

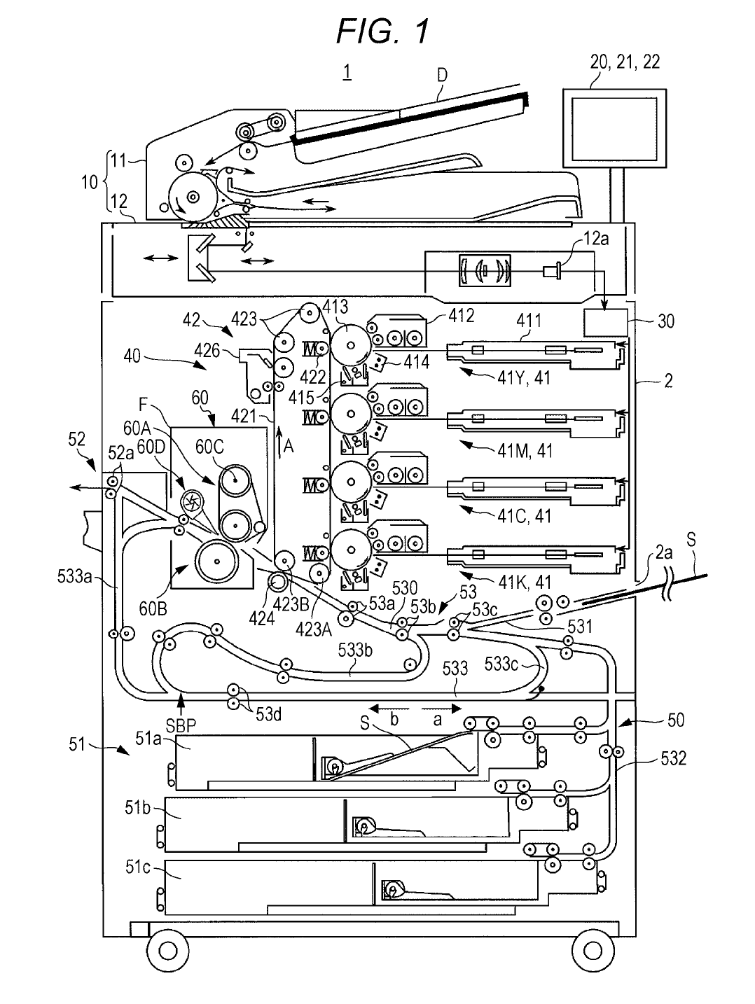

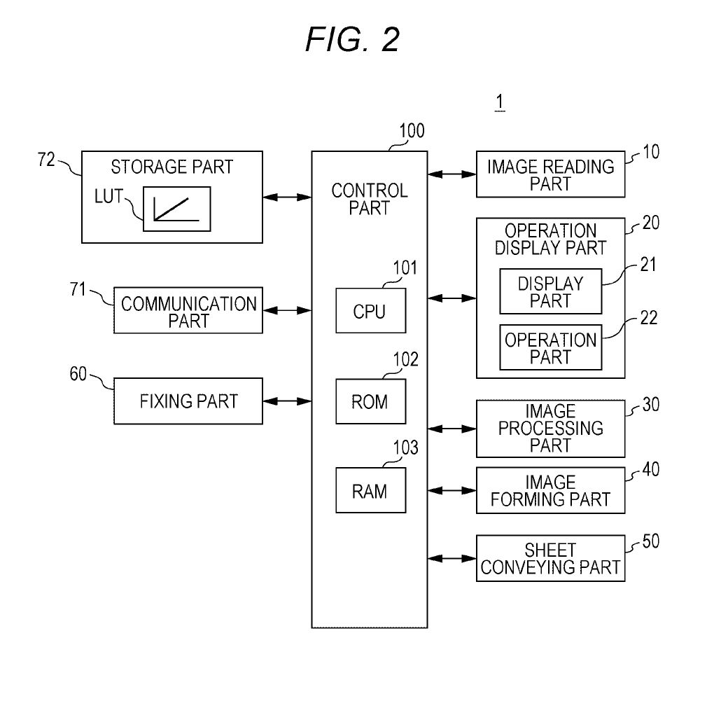

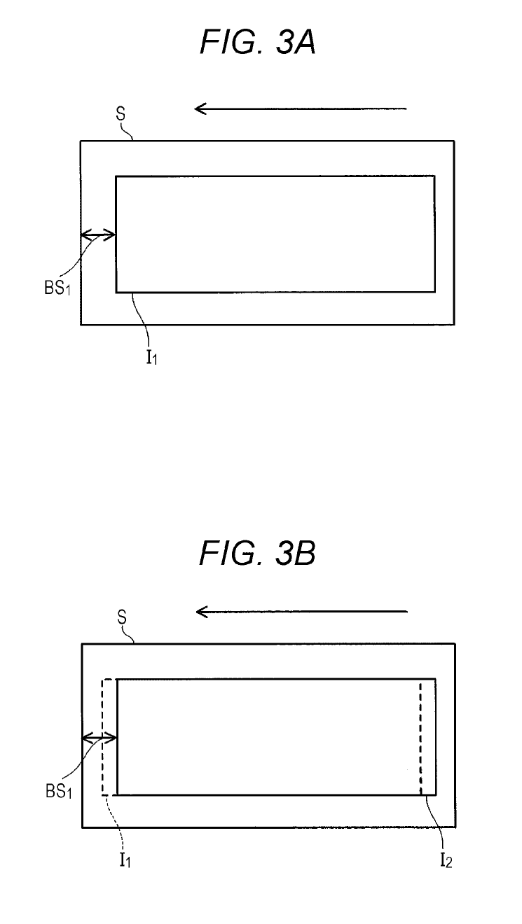

FIG. 1 is a diagram schematically showing an overall configuration of an image forming apparatus 1 according to an embodiment of the present disclosure. FIG. 2 shows a main part of a control system in the image forming apparatus 1 in the present embodiment. FIGS. 3A and 3B extract and show a conveying path for duplex printing in the image forming apparatus 1.

In the image forming apparatus 1 of the present embodiment, a long sheet or a non-long sheet is used as a sheet S, and an image is formed on the sheet S.

In the present embodiment, a long sheet is a sheet of paper having a longer length in the conveying direction than that of sheets generally used, such as ones of A4 size and A3 size, and has a length that cannot be accommodated in sheet feeding tray units 51a to 51c in the apparatus. Hereinafter, when simply referred to as “sheet”, both long sheet and non-long sheet may be included.

The image forming apparatus 1 is an intermediate transfer type color image forming apparatus utilizing an electrophotographic process technology. That is, the image forming apparatus 1 primarily transfers toner images of each color of yellow (Y), magenta (M), cyan (C), and black (K) formed on a photosensitive drum 413 to an intermediate transfer belt 421, superimposes four-color toner images on the intermediate transfer belt 421, and then secondarily transfers the toner images to the sheet S, thereby forming a toner image.

The tandem method is applied to the image forming apparatus 1, the tandem method of arranging the photosensitive drum 413 corresponding to the four colors of Y, M, C, and K in series in a traveling direction of the intermediate transfer belt 421, and transferring the toner images of each color sequentially to the intermediate transfer belt 421 in a single procedure.

As shown in FIG. 2, the image forming apparatus 1 includes an image reading part 10, an operation display part 20, an image processing part 30, an image forming part 40, a sheet conveying part 50, a fixing part 60, a control part 100, and the like.

The control part 100 includes a central processing unit (CPU) 101, a read only memory (ROM) 102, a random access memory (RAM) 103, and the like. The CPU 101 reads a program from the ROM 102 in accordance with processing contents, decompresses the program in the RAM 103, and cooperates with the decompressed program to centrally control the operation of each block of the image forming apparatus 1. At this time, various types of data stored in the storage part 72 are referred to. The storage part 72 includes, for example, a nonvolatile semiconductor memory (so-called flash memory) or a hard disk drive.

The control part 100 transmits or receives various types of data to or from an external device (for example, a personal computer) connected to a communication network such as a local area network (LAN) or a wide area network (WAN) via a communication part 71. For example, the control part 100 receives image data transmitted from an external device, and causes formation of a toner image on the sheet S on the basis of the image data (input image data). The communication part 71 includes a communication control card such as a LAN card.

The image reading part 10 includes an automatic document feeding device 11 called an auto document feeder (ADF), a document image scanning device 12 (scanner), or the like.

The automatic document feeding device 11 conveys a document D placed on a document tray by a conveyance mechanism and sends the document D to the document image scanning device 12. The automatic document feeding device 11 can consecutively read images of multiple sheets of documents D (including both surfaces) placed on the document tray at one time.

The document image scanning device 12 optically scans a document conveyed on a contact glass from the automatic document feeding device 11 or a document placed on the contact glass, and forms an image with reflected light from the document onto a light receiving surface of a charge coupled device (CCD) sensor 12a, to read a document image. The image reading part 10 generates input image data on the basis of a reading result by the document image scanning device 12. The input image data is subjected to predetermined image processing in the image processing part 30.

The operation display part 20 includes, for example, a liquid crystal display (LCD) with a touch panel, and functions as a display part 21 and an operation part 22. The display part 21 displays various operation screens, image status display, operation status of each function, or the like according to a display control signal input from the control part 100. The operation part 22 includes various operation keys such as a numeric key or a start key, accepts various input operations by a user, and outputs an operation signal to the control part 100.

The image processing part 30 includes a circuit or the like that performs digital image processing according to initial setting or user setting for input image data. For example, under the control of the control part 100, the image processing part 30 performs tone correction on the basis of tone correction data (tone correction table LUT) in the storage part 72. The image processing part 30 applies, in addition to the tone correction, various types of correction processing such as color correction or shading correction, compression processing, or the like to the input image data. The image forming part 40 is controlled on the basis of the image data subjected to these pieces of processing.

The image forming part 40 includes: image forming units 41Y, 41M, 41C, 41K for forming images with color toners of Y component, M component, C component, and K component on the basis of the input image data; an intermediate transfer unit 42; or the like.

The image forming units 41Y, 41M, 41C, 41K for Y component, M component, C component, and K component have similar configurations. For convenience of illustration and explanation, common components are denoted by the same reference numerals, and when distinguishing them, Y, M, C, or K is added to the reference numerals. In FIG. 1, only the components of the image forming unit 41Y for the Y component are denoted by reference numerals, and the reference numerals of the components of the other image forming units 41M, 41C, 41K are omitted.

The image forming unit 41 includes an exposure device 411, a developing device 412, the photosensitive drum 413, a charging device 414, a drum cleaning device 415, and the like.

The photosensitive drum 413 is a negative charge type organic photo-conductor (OPC) having an under coat layer (UCL), a charge generation layer (CGL), and a charge transport layer (CU) sequentially stacked on the circumferential surface of an aluminum conductive cylindrical body (aluminum element tube), for example. The charge generation layer is made of an organic semiconductor in which a charge generation material (for example, a phthalocyanine pigment) is dispersed in a resin binder (for example, polycarbonate), and generates a pair of positive and negative charges upon exposure by the exposure device 411. The charge transport layer is formed by dispersing a hole transporting material (electron donating nitrogen-containing compound) in a resin binder (for example, polycarbonate resin), and transports positive charges generated in the charge generation layer to the surface of the charge transport layer.

The control part 100 controls a driving current supplied to a driving motor (not shown) that rotates the photosensitive drum 413 to cause the photosensitive drum 413 to rotate at a constant circumferential speed (linear speed).

The charging device 414 uniformly charges the surface of the photosensitive drum 413 having photoconductivity to negative polarity. The exposure device 411 includes, for example, a semiconductor laser, and emits laser beams corresponding to images of each color component to the photosensitive drum 413. A positive charge is generated in the charge generation layer of the photosensitive drum 413 and transported to the surface of the charge transport layer, so that the surface charge (negative charge) of the photosensitive drum 413 is neutralized. An electrostatic latent image of each color component is formed on the surface of the photosensitive drum 413 due to a potential difference with the surroundings.

The developing device 412 is, for example, a two-component developing type developing device, and attaches toner of each color component to the surface of the photosensitive drum 413 to visualize the electrostatic latent image to form a toner image.

The drum cleaning device 415 includes a drum cleaning blade (hereinafter, simply referred to as a cleaning blade) or the like as a cleaning member which is in sliding contact with the surface of the photosensitive drum 413. The drum cleaning device 415 removes the transfer residual toner remaining on the surface of the photosensitive drum 413 after the primary transfer by the cleaning blade.

The intermediate transfer unit 42 includes an intermediate transfer belt 421 as an image carrier, a primary transfer roller 422, a plurality of support rollers 423, a secondary transfer roller 424, a belt cleaning device 426, or the like.

The intermediate transfer belt 421 is formed of an endless belt, and is looped around the plurality of support rollers 423. At least one of the plurality of support rollers 423 is formed of a driving roller, and the others are formed of a driven roller. For example, it is preferable that the roller 423A arranged downstream of the primary transfer roller 422 for the K component in the belt traveling direction is a driving roller. This makes it easier to keep the traveling speed of the belt at the primary transfer portion constant. As the driving roller 423A rotates, the intermediate transfer belt 421 travels at a constant speed in the direction of arrow A.

The primary transfer roller 422 is arranged on the inner circumferential surface side of the intermediate transfer belt 421 so as to face the photosensitive drum 413 of each color component. The primary transfer roller 422 is pressed against the photosensitive drum 413 with the intermediate transfer belt 421 in between so that a primary transfer nip for transferring a toner image from the photosensitive drum 413 to the intermediate transfer belt 421 is formed.

The secondary transfer roller 424 is arranged on the outer circumferential surface side of the intermediate transfer belt 421 so as to face a backup roller 423B arranged on the downstream side in the belt traveling direction of the driving roller 423A. The secondary transfer roller 424 is pressed against the backup roller 423B with the intermediate transfer belt 421 in between so that a secondary transfer nip for transferring the toner image from the intermediate transfer belt 421 to the sheet S is formed.

When the intermediate transfer belt 421 passes through the primary transfer nip, the toner images on the photosensitive drum 413 are sequentially superimposed and primarily transferred onto the intermediate transfer belt 421. Specifically, a primary transfer bias is applied to the primary transfer roller 422, and a charge having a polarity opposite to that of the toner is imparted to the back surface side of the intermediate transfer belt 421 (the side in contact with the primary transfer roller 422), so that the toner image is electrostatically transferred to the intermediate transfer belt 421.

Thereafter, when the sheet S passes through the secondary transfer nip, the toner image on the intermediate transfer belt 421 is secondarily transferred to the sheet S. Specifically, a secondary transfer bias is applied to the secondary transfer roller 424, and a charge having a polarity opposite to that of the toner is imparted to the back surface side of the sheet S (the side in contact with the secondary transfer roller 424), so that the toner image is electrostatically transferred to the sheet S. The sheet S to which the toner image has been transferred is conveyed toward the fixing part 60.

The belt cleaning device 426 includes a belt cleaning blade or the like in sliding contact with the surface of the intermediate transfer belt 421 and removes transfer residual toner remaining on the surface of the intermediate transfer belt 421 after the secondary transfer. Instead of the secondary transfer roller 424, a configuration (so-called belt-type secondary transfer unit) in which the secondary transfer belt is looped on a plurality of support rollers including a secondary transfer roller may be adopted.

The fixing part 60 includes an upper fixing part 60A having a fixing surface side member arranged on the side of a fixing surface (a surface on which a toner image is formed) of the sheet S, a lower fixing part 60B having a back surface side support member arranged on the back surface side (the surface opposite to the fixing surface) of the sheet S, a heating source 60C, and the like. The back surface side support member is pressed against the fixing surface side member, so that a fixing nip for nipping and conveying the sheet S is formed.

In the fixing part 60, the toner image is secondarily transferred, and the conveyed sheet S is heated and pressurized with the fixing nip so that the toner image is fixed on the sheet S. The fixing part 60 is arranged as a unit in a fixing device F. An air separation unit 60D that blows air to separate the sheet S from the fixing surface side member is arranged in the fixing device F.

The sheet conveying part 50 includes a sheet feeding part 51, a sheet discharging part 52, a conveying path part 53, and the like. Sheets S (standard sheet, special sheet) identified on the basis of basis weight (stiffness), size, or the like are accommodated in three sheet feeding tray units 51a to 51c constituting the sheet feeding part 51 for each preset type. The conveying path part 53 has a plurality of conveying rollers such as a registration roller pair 53a, a duplex conveying path for forming images on both surfaces of the sheet S, and the like. The details of the conveying path part 53 will be described later.

The sheets S accommodated in the sheet feeding tray units 51a to 51c are sent one by one from the uppermost part and are conveyed to the image forming part 40 by the conveying path part 53. At this time, the inclination of the fed sheet S is corrected and the conveyance timing is adjusted by the registration roller part in which the registration roller pair 53a is disposed. Then, in the image forming part 40, the toner image of the intermediate transfer belt 421 is secondarily transferred collectively to one surface of the sheet S, and the fixing process is performed in the fixing part 60. The sheet S on which an image is formed is discharged to the outside of the apparatus by the sheet discharging part 52 having a sheet discharging roller 52a.

Next, the conveying path part 53 will be described in detail.

The conveying path part 53 is a path in which the sheet S is conveyed when an image is formed on one surface (upper surface), and includes a main conveying path 530 in which the sheet S on which a toner image is formed in the image forming part 40 is conveyed. The main conveying path 530 is a path in which the sheet S is conveyed via the registration roller 53a, the secondary transfer nip of the image forming part 40, and the fixing part 60. The conveying path part 53 includes a reverse conveying path 533 for reversing the front and back of the sheet S.

The conveying path part 53 includes: an external sheet feeding conveying path 531 in which the sheet S such as a long sheet or the like fed from an external sheet feeding port 2a is conveyed to the main conveying path 530; and a sheet feeding conveying path 532 in which the sheet S fed from the sheet feeding tray units 51a to 51c is conveyed to the main conveying path 530.

The main conveying path 530 is provided above the sheet feeding tray units 51a to 51c inside the apparatus main body 2 and extends from one side portion of the apparatus main body 2 to the other side portion. One end portion of the main conveying path 530 is connected to the external sheet feeding conveying path 531 and the sheet feeding conveying path 532. The other end portion of the main conveying path 530 is connected to the discharge port of the discharging part 52 provided on the other side of the apparatus main body 2.

One end portion of the external sheet feeding conveying path 531 is connected to the external sheet feeding port 2a, and the other end portion thereof is connected to the main conveying path 530. The sheet feeding conveying path 532 is provided in the vicinity of one side portion in the apparatus main body 2 and extends vertically from the sheet feeding tray units 51a to 51c to the main conveying path 530. The upper end portion of the sheet feeding conveying path 532 is connected to the main conveying path 530, and the lower end portion is connected to the sheet feeding tray units 51a to 51c.

The reverse conveying path 533 is provided between the sheet feeding tray units 51a to 51c and the main conveying path 530 inside the apparatus main body 2 and extends from the other side portion of the apparatus main body 2 to one side portion. The reverse conveying path 533 includes a first returning conveying path 533a branching downward from the main conveying path 530 on the downstream side of the fixing part 60 in the conveying direction of the sheet S conveyed through the main conveying path 530, and a second returning conveying path 533b that joins the main conveying path 530 on the upstream side of the secondary transfer nip of the image forming part 40.

One end of the reverse conveying path 533 is connected to the first returning conveying path 533a and the second returning conveying path 533b. Here, one end portion of the reverse conveying path 533 connected to the first returning conveying path 533a and the second returning conveying path 533b serves as a switchback point SBP in which the forward and reverse of the traveling direction (conveying direction) of the sheet S is switched during duplex printing. Hereinafter, in the reverse conveying path 533, the conveying direction indicated by the arrow a in which the sheet S is conveyed from the first returning conveying path 533a is referred to as a positive direction, and the conveying direction indicated by the arrow b in which the sheet S is conveyed to the second returning conveying path 533b is referred to as a reverse direction.

The reverse conveying path 533 is provided with a conveying roller 53d as a switchback roller on the downstream side in the conveying direction in the positive direction with respect to the switchback point SBP. The driving force of a motor (not shown) is transmitted to the conveying roller 53d, and the conveying roller 53d conveys the sheet S to both the forward direction and the reverse direction.

On the downstream side of a conveying roller 53b in the conveying direction of the reverse conveying path 533 in the forward direction, a joining conveying path 533c as a double-sided path joining the main conveying path 530 and connecting the reverse conveying path 533 and the main conveying path 530.

The joining conveying path 533c is a double-sided path used for duplex printing of the sheet S (mainly long sheet), and joins the main conveying path 530 on the upstream side of the registration roller 53a in the conveying direction of the sheet S conveyed in the forward direction. In this example, the joining conveying path 533c joins on the upstream side of the joining point between the main conveying path 530 and the second returning conveying path 533b. The joining conveying path 533c joins the main conveying path 530 in a direction in which the sheet S is conveyed in the left direction in the drawing of the main conveying path 530. The reverse conveying path 533 joins the main conveying path 530 in this manner, so that duplex printing of a long sheet can be realized while preventing the apparatus main body 2 and the entire image forming apparatus 1 from becoming larger. That is, in the image forming apparatus 1, it is possible to perform duplex printing of a long sheet having a longer size in the conveying direction by passing the long sheet through the joining conveying path 533c before and after the switchback operation.

Next, the conveying operation during duplex printing will be described.

When the sheet S is non-long sheet, the sheet S is fed one by one from any one of the sheet feeding tray units 51a to 51c, and is conveyed to the main conveying path 530 via the sheet feeding conveying path 532. On the other hand, when the sheet S is a long sheet, the sheet S (long sheet) is conveyed from the external sheet feeding port 2a of the apparatus main body 2 to the main conveying path 530 via the external sheet feeding conveying path 531.

The sheet S (non-long sheet or long sheet) conveyed to the main conveying path 530 is conveyed in the main conveying path 530 in the forward direction (the left direction in FIG. 1), passes through the image forming part 40 and the fixing part 60, so that the toner image is transferred and fixed on the upper surface (first surface).

Subsequently, the conveyance of the sheet S is controlled by the control part 100 so that the sheet S is conveyed from the main conveying path 530 to the reverse conveying path 533 via the first returning conveying path 533a. When the rear end of the sheet S in the conveying direction passes the switchback point SBP, the control part 100 switches the direction of rotation of the conveying roller 53d to reverse the conveying direction, and causes the sheet S to be conveyed from the reverse conveying path 533 to the main conveying path 530 via the second returning conveying path 533b.

Here, in the case where the sheet S is a non-long sheet, in the conveyance in the forward direction indicated by the arrow a, before the tip end of the sheet S enters the joining conveying path 533c, the rear end of the sheet S passes the switchback point SBP. On the other hand, when the sheet S is a long sheet, the tip end of the sheet S enters the joining conveying path 533c in the forward direction, and then the rear end of the sheet S passes the switchback point SBP.

Subsequently, the sheet S (non-long sheet or long sheet) is conveyed to the main conveying path 530 with the first surface, which is the image forming surface, facing downward through the second returning conveying path 533b, and an image is formed on the second surface facing upward. The control part 100 controls the conveyance of the sheet S on which toner images are formed on both surfaces so that the sheet S is discharged from the main conveying path 530 to the discharging part 52.

Incidentally, in recent years, there is a growing demand for aligning positions of toner images formed on a front surface (first surface) and a back surface (second surface) of the sheet S at the time of duplex printing. Such a demand arises, for example, when post-processing is performed such as performing duplex printing on a plurality of sheets S, folding these sheets S by center folding, binding, or appropriately cutting margin portions and binding. In response to this request, as described above, a technology of correcting an image formation position in a sub scanning direction (conveying direction of the sheet S) is not sufficiently effective at present.

Particularly, in the image forming apparatus 1 that performs duplex printing by the switchback conveyance method as described above, the tip end/rear end in the conveying direction of the sheet S is reversed between the first surface and the second surface. In this case, since it is influenced by the outline of the sheet S (that is, the difference in shape of the tip end/rear end) during duplex printing, formation positions of a toner image in the sheet conveying direction or the sub scanning direction (hereinafter also simply referred to as a conveying direction) can be accurately aligned.

In addition, in the long sheet, as the length of the sheet S becomes longer, the variation in the length tends to become larger, so that it is difficult to accurately align formation positions of toner images in a conveying direction between the first surface and the second surface at the time of duplex printing.

Hereinafter, such a problem will be described more specifically with reference to FIGS. 3A to 5. FIGS. 3A and 3B are diagrams for explaining problems in the case of performing duplex printing in a conventional image forming apparatus, in which an image I₁ formed on the first surface of the sheet S during execution of a duplex printing job is shown in FIG. 3A, and the image I₂ formed on the second surface is shown in FIG. 3B. Here, it is assumed that the image I₁ and the image I₂ are images of the same size, and the setting of the margin length (the length BS₁ indicated by the double-headed arrow) from the tip end of the sheet is also the same on the first surface and the second surface.

As can be understood by comparing FIGS. 3A and 3B, both the image I₁ printed on the first surface and the image I₂ printed on the second surface have the same margin length BS₁ from the tip end in the conveying direction of the sheet S. On the other hand, in the model adopting the switchback method, since the tip end in the conveying direction is reversed between the first surface and the second surface, as a result, as shown in FIG. 3B, formation positions of the images (I₁, I₂) printed on each surface of the same sheet S in the conveying direction are shifted from each other. For this reason, for example, in the case of binding a plurality of duplex-printed sheets S, it is necessary to repeat setting of margins and experimental printing, resulting in a problem of poor productivity.

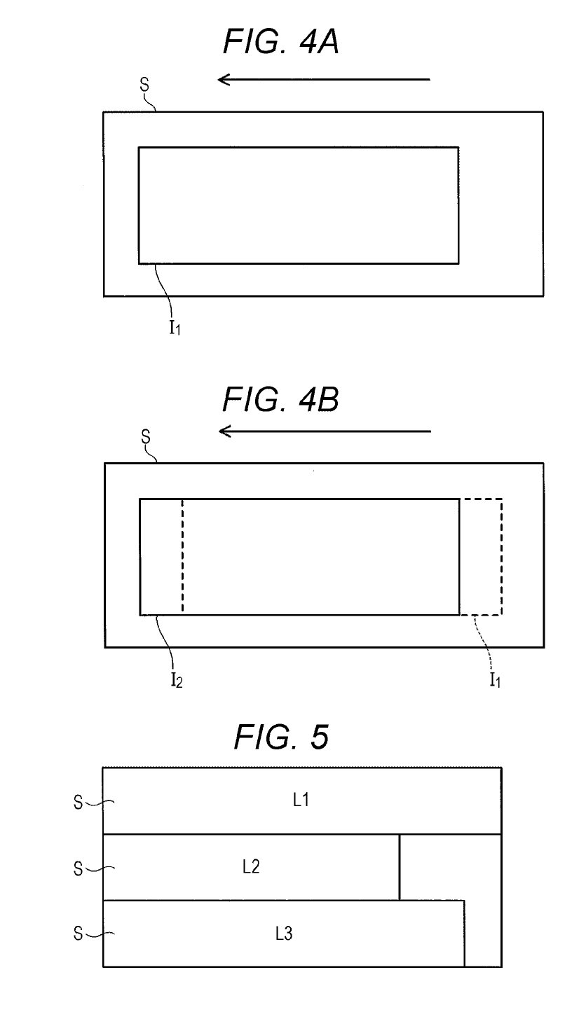

FIGS. 4A and 4B show an example in which the image I₁ and the image I₂ are printed on the first surface and the second surface when the length of the sheet S in the conveying direction is longer than in the example of FIGS. 3A and 3B. In the example shown in FIGS. 4A and 4B, it can be seen that the margin on the rear end side in the conveying direction of the sheet S is larger, and the shift amount of the formation positions on the sheet S of the printed images (I₁, I₂) is larger.

Furthermore, as shown in an exaggerated manner in FIG. 5, as the length of the sheet S becomes longer, there is a tendency that the variation of the sheet S at the time of manufacturing becomes larger. Specifically, even with a sheet package of the same size by the same manufacturer, variation may occur in some cases in the length of the sheet S in each lot (L1 to L3 in FIG. 5) depending on the timing of cutting, the lot of packaging, or the like (about 0.2 to 0.5 mm).

In addition, during duplex printing, the size of the sheet S can be slightly varied through the pressurization and heating process by the fixing part 60.

Thus, the length of the sheet S is not in accordance with the prescribed size, but rather the length usually includes some error or variation. Under such circumstances, adopting the configuration of repeatedly reading the information on the surface of the sheet S using the image sensor as described above is disadvantageous in terms of productivity, cost, or the like of printing in the case of duplex printing of a long sheet, consecutive conveyance of a plurality of sheets S.

In addition, the variation in the length of the sheet S during manufacturing can be larger than the fluctuation value of the length generated during the fixing process. Therefore, a more effective configuration corresponding to a job of conveying a plurality of sheets S consecutively and performing duplex printing is required.

Therefore, in the present embodiment, a control is performed such that the length of the sheet S is measured on the basis of the passing timing of the tip end and the rear end of the sheet S being conveyed, and the formation positions in the sheet conveying direction of the toner images are aligned between the first surface and the second surface of the sheet S on the basis of the measurement result.

More specifically, in the present embodiment, as a sheet length measuring part for measuring the length in the conveying direction of the sheet S (hereinafter, referred to simply as the length), an end portion detection sensor (hereinafter, referred to as a conveyance sensor) for detecting the passage of an end portion (tip end and rear end) in the conveying direction of the sheet S is arranged in the conveying path.

The control part 100 performs control so as to change the image formation position along the conveying direction of the toner image formed on the sheet S according to the variation in the length of the sheet S obtained from the detection result of the conveyance sensor. More specifically, the control part 100 specifies a difference with respect to the reference value of the length of the sheet S from the detection result of the conveyance sensor, and in accordance with the difference, mainly controls the sheet conveying part 50 (registration roller pair 53a or the like) to correct the formation position in the conveying direction of the toner image formed on the sheet S.

Here, the conveyance sensor is an optical type sensor including a light emitting part that emits light and a light receiving part that receives the emitted light (or its reflected light), a sensor of a physical type which is in the ON state when being pushed by the sheet S during passage of the sheet S, or the like can be used. In the image forming apparatus 1, since the control part 100 recognizes in advance the conveying speed of the sheet S, the control part 100 can measure the length of the sheet S from the passing time of the tip end and the rear end of the sheet S detected by the sensor.

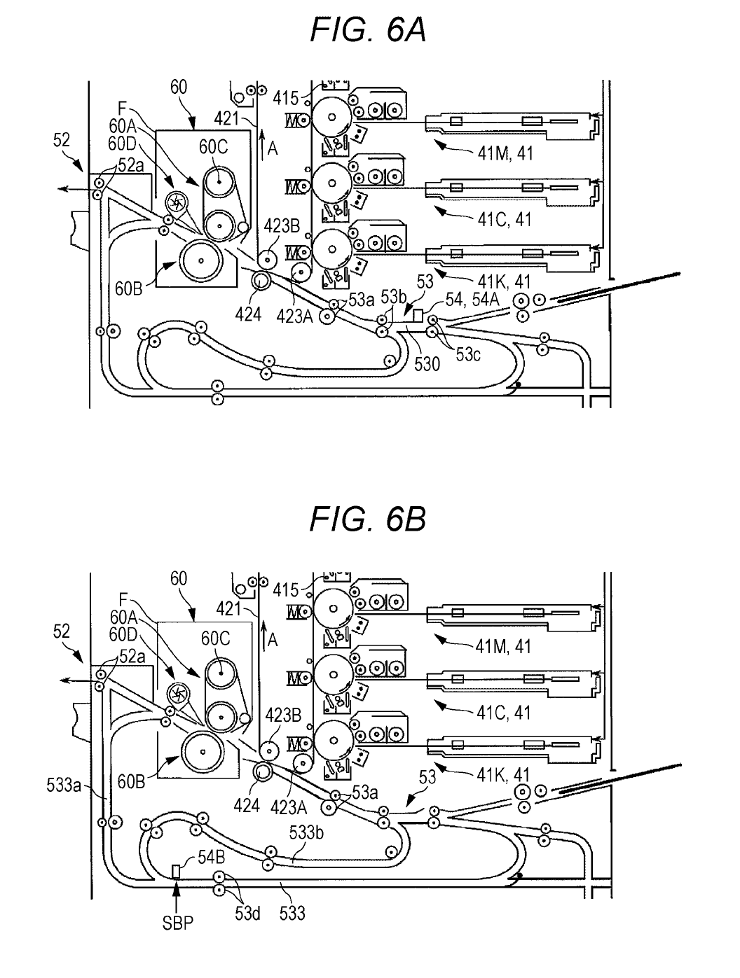

An example of arrangement of conveyance sensors will be described with reference to FIGS. 6A and 6B. FIGS. 6A and 6B show an example in which optical conveyance sensors 54 (54A, 54B) that detect the tip end and the rear end in the conveying direction of the sheet S are arranged on different conveying paths.

These conveyance sensors 54A, 54B have, for example, known light emitting elements and light receiving elements, and output detection signals corresponding to the amount of light received by the light receiving elements of the reflected light of the light emitted from the light emitting elements to detect the passage of the tip end and the rear end of the sheet S.

The conveyance sensor 54A shown in FIG. 6A is a sensor that measures a value related to the length of the sheet S at the time of printing of the first surface (that is, the passing timing of the tip end/rear end of the sheet S). The conveyance sensor 54A is arranged in the main conveying path 530 on the downstream side of the conveying roller 53c and on the upstream side of the conveying roller (loop roller) 53b. Here, the sheet S (non-long sheet) fed from the sheet feeding tray units 51a to 51c and conveyed to the main conveying path 530 and the tip end and the rear end of the sheet S (long sheet) conveyed to the main conveying path 530 via the external sheet feeding conveying path 531 are detected by the conveyance sensor 54A. Specifically, when the tip end (rear end) of these sheets S passes the position of the conveyance sensor 54A in the main conveying path 530, a detection signal is output from the conveyance sensor 54A to the control part 100, and the control part 100 specifies the passing timing (time) of the tip end (rear end) of the sheet S.

On the other hand, the conveyance sensor 54B shown in FIG. 6B is a sensor that measures a value related to the length of the sheet S at the time of printing of the second surface, and is arranged at the position of the switchback point SBP in the reverse conveying path 533. Here, the sheet S (non-long sheet or long sheet) is conveyed from the main conveying path 530 to the reverse conveying path 533 via the first returning conveying path 533a after the toner image of the first surface is fixed, and when the tip end and the rear end of the sheet S pass the switchback point SBP, the passage is detected by the conveyance sensor 54B. Specifically, when the tip end and the rear end of the sheet S pass the position of the conveyance sensor 54B in the reverse conveying path 533, a detection signal is output from the conveyance sensor 54B to the control part 100, and the control part 100 specifies the passing timing (time) of the tip end and the rear end of the sheet S.

According to the present embodiment in which the conveyance sensor 54 detects the passing timing (time) of the tip end and the rear end of the conveyed sheet S in this way, as compared with a method of sensing the surface of the entire sheet S with an image sensor or the like, the productivity, cost, or the like of the printing can be improved.

With the configuration in which the conveyance sensor 54 is provided for each of the path for printing of the first surface of the sheet S and the path for printing of the second surface, the length of the sheet S before and after the fixing process can be measured at the time of execution of the duplex printing job.

In the present embodiment, at the time of duplex printing job, the control part 100 calculates the difference (that is, the variation in the length of the sheet S) with respect to the reference value of the length of the sheet S from the measurement result by the conveyance sensor 54 (54A or 54B, the same hereinafter). Then, the control part 100 controls the sheet conveying part 50 including the pair of registration rollers 53a to change the image formation position along the sheet conveying direction of the image (I₁ or I₂) to be formed on the sheet S, on the basis of the calculated difference. With such control, even when duplex printing is performed while a plurality of sheets S are consecutively conveyed, it is possible to improve the productivity, the cost, or the like of printing, and to align the positions of the images I₁ and I₂ formed on both surfaces of the sheet S.

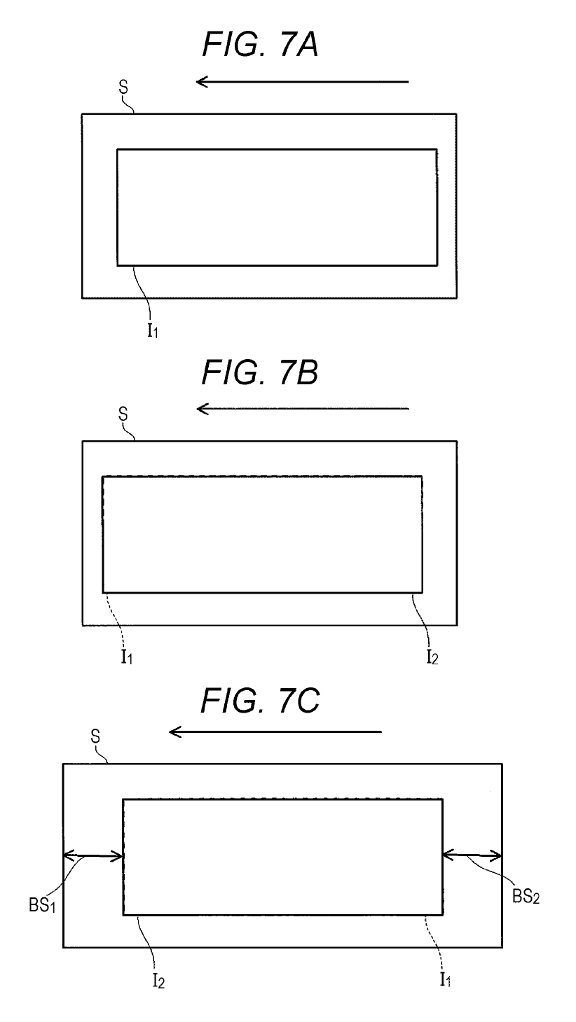

Specifically, as shown in FIGS. 7A and 7B, the control part 100 performs control so as to correct the image formation position of at least the second surface such that the formation positions in the sheet S of the image I₁ formed on the first surface of the sheet S and the image I₂ formed on the second surface of the same sheet S coincide with each other. Here, FIGS. 7A and 7B are diagrams corresponding to the example of FIGS. 3A and 3B described above. As can be understood by comparing FIGS. 7A and 7B, in this example, the control part 100 correct the image formation position of the second surface such that the position of the image to be printed on the second surface (back surface) of the sheet S coincides with the image position of the first surface (front surface) of the first surface (front surface). As a result, it can be seen that the margin area from the tip end of the second surface in the conveying direction is changed (decreased).

The control of the image position alignment in duplex printing as shown in FIG. 7B can be realized by adjusting the conveying speed of the sheet S at the time of printing on the second surface (in this example, advancing the timing at which the sheet S enters the secondary transfer nip). Alternatively or additionally, such image position alignment control can be realized also by adjusting the position of the toner image formed on the photosensitive drum 413 (formation position in the rotation direction, that is, the sub scanning direction) at the time of printing of the second surface of the sheet S.

On the other hand, in duplex printing, the sheet S contracts (or expands) during printing of the second surface due to the fixing process (heating and pressurizing) by the fixing part 60, and the sheet S is smaller (or larger) than that at the time of printing of the first surface. At this time, the size of the image I₁ printed on the first surface also changes from the original size according to the deformation mode of the sheet S. Therefore, in order to make the formation positions of the images (I₁, I₂) of the same size coincide with each other on both surfaces, the control part 100 sets the magnification in the conveying direction of the toner image formed on the photosensitive drum 413 to be slightly decreased (or increased) according to the length of the sheet S measured through the conveyance sensor 54B during printing of the second surface. In this case, strictly speaking, the image becomes distorted. However, if the distortion (variation magnification) is such that the user does not notice it visually, there is no need to adjust the magnification in the sheet width direction of the toner image.

In a specific example, at the time of a duplex printing job, the control part 100 acquires the value of the size (width×length) of the sheet S to be used from a preset sheet profile or the like, and uses, as a reference value, a value obtained by dividing a value of the length (a reference length as an ideal value) of the sheet S by a value of the sheet conveying speed. In other words, the time (passage time) during which the tip end and the rear end of the sheet S having the ideal value length are to be detected by the conveyance sensor 54 is used as a reference value (reference time).

Then, the control part 100 determines the difference with respect to the reference value (reference time) from the passing timing of the tip end and the rear end of the sheet S measured through the conveyance sensor 54A during conveyance of the sheet S, to specify the length (or difference value of length) of the sheet S.

Subsequently, the control part 100 performs control to form a toner image on the photosensitive drum 413, and when the formed toner image reaches the secondary transfer nip via the intermediate transfer belt 421, the control part 100 performs control to align the positions in the sub scanning direction of the sheet S to be conveyed and the toner image. As a specific example, the control part 100 controls the rotation of the conveying roller such as the pair of registration rollers 53a such that the tip end side of the toner image that has been primarily transferred on the intermediate transfer belt 421 is secondarily transferred in the tip end side of the sheet S (the first surface) with the margin area set by the user secured. With such control, as shown in FIG. 7A, a toner image (image I₁) is secondarily transferred to a desired position from the tip end in the sub scanning direction (that is, the conveying direction) on the sheet S.

Subsequently, the control part 100 conveys the sheet S to the fixing part 60, switches back the sheet S at the switchback point SBP via the duplex conveying path described above, and conveys the sheet S to the secondary transfer nip again. At this time, the control part 100 determines the difference with respect to the reference value (reference time) from the passing timing of the tip end and the rear end of the sheet S measured through the conveyance sensor 54B during conveyance of the sheet S, to specify the length (or difference value of length) of the sheet S again.

At the time of the secondary transfer of the toner image on the second surface, the control part 100 controls the rotation of the conveying roller such as the pair of registration rollers 53a such that the toner image is secondarily transferred at the position on the sheet S that coincides with the position of the toner image formed on the first surface of the sheet S.

In one example, the control part 100 controls the rotation of the pair of registration rollers 53a such that the rear end position in the conveying direction of the toner image secondarily transferred on the first surface of the sheet S and the tip end position in the conveying direction of the toner image formed on the second surface of the sheet S coincide with each other.

By such control, as shown in FIG. 7B, the toner image (image I₂) is secondarily transferred to the same position on the two-dimensional plane as the formation position of the image I₁ on the first surface of the sheet S. As a result, the margin area from the tip end side of the sheet S set by the user is applied to the first surface of the sheet S, but is not applied to the second surface of the sheet S.

As another control example, as shown in FIG. 7C, the control part 100 may perform control such that the center position of the image I₁ formed on the first surface of the sheet S in the conveying direction and the center position of the image formed on the second surface of the sheet S in the conveying direction coincide with each other. In this case, the margin length BS₁ in the tip end side of the sheet S is equal to the margin length BS₂ in the sheet rear end side.

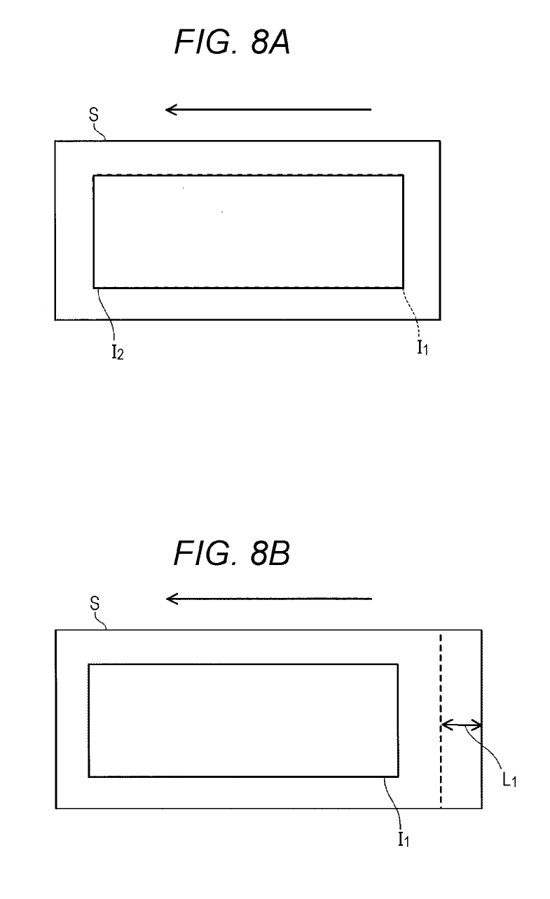

Next, referring to FIG. 8 (FIGS. 8A and 8B), a case where duplex printing is performed by consecutively conveying a plurality of sheets S (long sheets) will be described. In FIGS. 8A and 8B, a case where duplex printing is performed on the sheet S having the reference length (ideal value) is hypothetically shown in FIG. 8A, and an example of the sheet S actually conveyed is shown in FIG. 8B. FIG. 8B shows a case where the sheet S has the length than the reference length by L₁.

When executing a duplex print job, the control part 100 acquires the reference length value of the sheet S (long sheet) to be used and sets the reference length value in a memory or the like, and as described above with reference to FIGS. 7A to 7C, the control part 100 controls the rotation of the pair of registration rollers 53a such that the rear end position in the conveying direction of the toner image secondarily transferred on the first surface of the sheet S and the tip end position in the conveying direction of the toner image formed on the second surface of the sheet S coincide with each other.

During execution of such a duplex printing job, the control part 100 calculates the difference with respect to the reference length from the measured value (passing timing of the tip end and the rear end) of the sheet S by the conveyance sensor 54 (54A or 54B) with respect to a preset reference length. Then, the control part 100 performs control to correct the image formation position of at least the toner image (image I₂) formed on the second surface according to the difference value that has been calculated.

FIG. 8A is a diagram corresponding to FIG. 7B, in which control is performed such that formation positions in the image I₁ of the first surface and the image I₂ of the second surface coincide with each other while a margin area from the tip end side of the first surface of the sheet S (long sheet) set by the user is secured. On the other hand, as described above, a long sheet tends to have a large manufacturing error, and as described above in FIG. 5, the length tends to change as the lot changes.

Thus, the control part 100 calculates the difference length (the surplus length L₁ in the example of FIG. 8B) with respect to the reference length from the measured value (passing timing of the tip end and the rear end) of the sheet S by the conveyance sensor 54 (54A or 54B) with respect to a preset reference length. Then, the control part 100 performs control to correct the image formation position of at least the toner image (image I₂) formed on the second surface according to the difference length that has been calculated. In the example shown in FIG. 8B, the control part 100 shifts the formation position of the image I₂ to be formed on the second surface by the extra length L1 to the downstream side in the conveying direction, so that the formation positions of the image I₁ of the first surface and the second image I₂ of the second surface are aligned with each other.

As described above, according to the configuration in which the difference with respect to a specific reference sheet as shown in FIG. 8A is calculated and the image formation position on the sheet S is adjusted on the basis of the calculated relative length of the sheet S, it is possible to improve the productivity in the case where a plurality of sheets S are consecutively conveyed and duplex printing is performed.

In the present embodiment, the formation position in the conveying direction of the toner images (images I₁ and I₂) to be printed on the sheet S can be switched according to a post-processing method or the like.

For example, in the case of performing binding or the like by a center folding method, even if the size of the sheet S changes before and after the fixing process, basically, it is acceptable as long as the center (that is, the center folded portion) in the conveying direction of the sheet S and the center portion of the image are aligned (see FIG. 7C). In this case, it is possible to obtain accuracy by appropriately cutting the end portion of the sheet S after folding the center of the sheet S.

On the other hand, when binding or the like is performed by a case binding method, it is preferable to align the image with the end portion of the sheet S in order to reduce the area of the sheet S and the cutting process itself.

In consideration of the above, in the present embodiment, the buttons for selecting the post-processing method (“center folding”, “case binding” or the like) are selectably displayed on the user setting screen or the like, and the control part 100 determines the transfer position in the conveying direction of the toner image to be secondarily transferred to the sheet S according to the selection by the user.

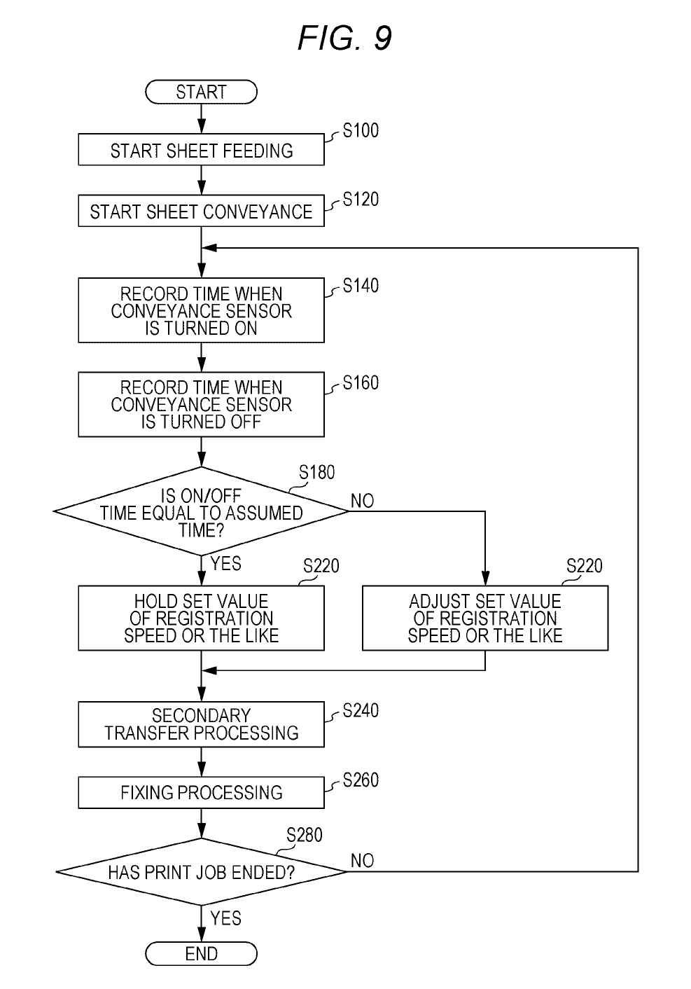

Next, with reference to the flowchart of FIG. 9, a control example at the time of execution of the duplex printing job of the image forming apparatus 1 will be described. In the example of FIG. 9, both the conveyance sensor 54A described with reference to FIG. 6A and the conveyance sensor 54B described with reference to FIG. 6B are provided, and the formation positions (secondary transfer position) of the images I₁ and I₂ are set at the center of the sheet S (see FIG. 7C).

At the time of start of a print job, the control part 100 acquires the value of the length in the conveying direction of the sheet S to be used from the size information of the sheet set through a user setting screen (not shown) or the like, and sets the length of the sheet S as a reference value in a memory or the like. The control part 100 sets a value related to the length of the sheet S (that is, the passing time of the tip end to the rear end of the sheet S) detected by the conveyance sensor 54 (54A and 54B) from the value of the predetermined sheet conveying speed, in the memory or the like as a reference value (assumed time) of passing time. The control part 100 specifies the sizes of the images and I₂) formed on the sheet S from the input image information, and sets the length (BS) of the margins at the tip end side and the rear end side of the sheet S (in this example BS₁=BS₂).

In step S100, the control part 100 outputs a drive signal to the sheet feeding tray units 51a to 51c in the apparatus or a sheet feeding roller (not shown) of the sheet feeder outside the apparatus to start feeding of the sheet S. Thereafter, the control part 100 starts conveyance of the sheet S by driving each conveying roller of the sheet conveying part 50 so as to convey the sheet S at a constant speed in the main conveying path 530 (step S120).

Subsequently, the control part 100 monitors the detection signal of the conveyance sensor 54A (see FIG. 6A) and records the time at which the conveyance sensor 54A is turned on (that is, the passing time of the tip end of the sheet S) in a memory or the like (step S140). Further, the control part 100 records the time at which the conveyance sensor 54A is turned off (that is, the passing time of the rear end of the sheet S) in a memory or the like (step S160).

In the subsequent step S180, the control part 100 determines whether the period from on to off of the conveyance sensor 54A recorded in steps S140 and S160 (that is, the passing time of the tip end to the rear end of the sheet S) is equal to the assumed time.

Here, when determining that the period is equal to the assumed time (YES in step S180), the control part 100 determines that the length of the sheet S is equal to the reference value and holds the setting of the conveying speed of the pair of registration rollers 53a or the like (step S200). In this case, the control part 100 performs a normal transfer and fixing process (steps S240 and S260).

On the other hand, when determining that the length of the sheet S is different from the assumed time (is not equal to the assumed time) (NO in step S180), the control part 100 determines that the length of the sheet S is different from the reference value and proceeds to step S220.

In step S220, the control part 100 changes the setting of the conveying speed of the registration roller pair 53a. Specifically, the control part 100 specifies the shift amount (see FIG. 8B) from the reference value of the length of the sheet S and changes the setting of the conveying speed of the registration roller pair 53a so as to adjust the timing at which the tip end of the sheet S reaches the secondary transfer nip, according to the shift amount.

Subsequently, the control part 100 rotates the registration roller pair 53a at the conveyance speed according to the set value adjusted in step S220 to send the tip end of the sheet S to the secondary transfer nip (step S240). With this operation, the toner image can be secondarily transferred on the sheet S such that the position of the margin from the tip end in the conveying direction of the sheet S is made to coincide with a predetermined position (a correct position desired by the user, in this example, the position satisfying BS₁=BS₂). Then, the control part 100 conveys the sheet S on which the toner image has been secondarily transferred to the fixing part 60 and performs the fixing process (step S260).

In step S280, the control part 100 determines whether the print job for the sheet S has ended.

Here, when determining that that the print job has not ended (NO in step S280), in order to perform printing of the second surface of the sheet S, the control part 100 performs control of conveyance such that the sheet S is sent again to the main conveying path 530 through the duplex conveying path, and returns the process to step S140.

At this time, before the switchback operation is performed for the sheet S that has been conveyed to the duplex conveying path, the passage of the tip end and the rear end of the sheet S is detected by the conveyance sensor 54B (see FIG. 6B) arranged at the switchback point SBP. Accordingly, the control part 100 monitors the detection signal of the conveyance sensor 54B and records the time at which the conveyance sensor 54B is turned on (that is, the passing time of the tip end of the sheet S) in a memory or the like (step S140). Further, the control part 100 records the time at which the conveyance sensor 54B is turned off (that is, the passing time of the rear end of the sheet S) in a memory or the like (step S160).

In the subsequent step S180, the control part 100 determines whether the period from on to off of the conveyance sensor 54B (that is, the passing time of the tip end to the rear end of the sheet S) is equal to the assumed time. Hereinafter, as similar to the above, the control part 100 performs the processing of step S200 to step S260 and performs processing of printing the image I₂ on the second surface of the sheet S.

In the processing of step S220 at the time of the printing of the second surface of the sheet S, the control part 100 determines whether the set value adjusted in step S220 (that is, the correction amount of the image formation position) at the time of printing of the first surface of the sheet S may be regarded as a base, and the set value may be corrected according to the detection result of the conveyance sensor 54B.

When determining that the print job for the sheet S has ended (YES in step S280), the control part 100 ends the series of processes described above in step S280 after the fixing process of the second surface ends. In the case of a duplex printing job for a plurality of sheets S, the control part 100 repeatedly performs the series of processes described above until the fixing processing of the second surface of the last sheet S is completed.

As another example of step S220, the control part 100 specifies the shift amount from the reference value of the length of the sheet S, and the control part 100 adjusts the formation position in the sub scanning direction of the toner image formed on the developing roller (image carrier) according to the shift amount. Alternatively, the control part 100 may adjust the magnification in the conveying direction of the toner image formed on the developing roller (image carrier) according to the shift amount from the reference value of the length of the sheet S. In this case, as described above, if the distortion (variation magnification) is such that the user does not notice it visually, there is no need to adjust the magnification in the sheet width direction of the toner image.

As another example of the conveyance sensor 54 (54A, 54B), a laser Doppler speed meter can be used. In this case, the length of the sheet S in the conveying direction may be measured from the passing time of the tip end or rear end of the conveying speed of the sheet S measured by the laser Doppler speed meter. On the other hand, since the conveying speed of the sheet S is grasped by the control part 100, there is no need to operate the laser Doppler speed meter in all the periods during the passage of the sheet S, and it is sufficient that the tip end and the rear end of the sheet S in the conveying direction are detected with a laser Doppler speed meter. Accordingly, the control part 100 may operate the laser Doppler speed meter at the timing when the tip end and the rear end of the sheet S in the conveying direction pass.

As another configuration example of measuring the length of the sheet S being conveyed, the length of the sheet S may be measured from the torque fluctuation of the motor driving the conveying roller. In a specific example, the control part 100 considers that the tip end of the sheet S enters the conveying roller at the timing when the torque of the motor driving the conveying roller increases, and considers that the rear end of the sheet S exits the conveying roller at the timing when the torque decreases.

According to the image forming apparatus 1 that performs the control of adjusting the image formation position in the conveying direction on the basis of the measurement result of the passing timing of the tip end and the rear end of the sheet S to be conveyed as described above, it is possible to align the image formation positions in the conveying direction on the first surface and the second surface of the sheet S while the productivity in duplex printing is secured.

In the control example described above, not only the transfer position of the image to be secondarily transferred onto the second surface of the sheet S, but also the transfer position of the image to be secondarily transferred to the first surface is adjusted. In this case, depending on the setting of the margin area or the like, the position of the toner image can be made coincide with the tip end or the rear end of the sheet S to the extent that the subsequent cutting is unnecessary.

On the other hand, in the case of control to adjust also the transfer position of the image to be secondarily transferred to the first surface, it may be necessary to wait for the timing at which the toner image is secondarily transferred, such as lowering the conveying speed of the sheet S to enter the secondary transfer nip from the first surface (or the sheet S is temporarily stopped). Therefore, from the viewpoint of productivity in duplex printing, there is room for improvement. In other words, in order to improve productivity, there is a case that it is better not to perform the above-described processing of step S180 and step S220 during printing of the first surface of the sheet S.

Therefore, it is preferable that, prior to the execution of the duplex printing job, whether or not to adjust the formation position in the conveying direction of the image to be printed on the first surface of the sheet S is set so that the user can arbitrarily set through the user setting screen. For example, when two buttons of “productivity mode” and “image quality mode” are selectably displayed on the user setting screen and the “productivity mode” is selected, the control part 100 performs the processing of step S180 and step S220 only when the second surface of the sheet S is printed. That is, when the “productivity mode” is selected, the control part 100 performs control of not correcting the transfer position (formation position) of the image in the printing of the first surface of the sheet S, and correcting the transfer position in the printing of the second surface of the sheet S.

In the “productivity mode”, the control part 100 determines the difference value of the length of the sheet S (that is, the change amount of the sheet length before and after passing through the fixing part 60) measured by using the conveyance sensors 54A and 54B. Then, the control part 100 feeds back the difference value (change amount) so as to make the difference value (change amount) be used in the conveyance control of the toner image to be formed on the second surface of the sheet S (the magnitude in the conveying direction of the image as necessary).

In particular, in the case of duplex printing of a long sheet, contraction of the sheet length may occur due to heat applied to the sheet S due to execution of the fixing process. Even in such a case, the control part 100 can estimate the length of the sheet S from the change amount of the variation of the section (time) from the tip end to the rear end of the sheet S detected by the conveyance sensors 54A and 54B.

Basically, the contraction ratio of the sheet length associated with the execution of the fixing process can be specified (that is, predicted) to some extent from the amount of heat applied to the sheet S and the sheet type of the sheet S. Accordingly, the control part 100 may predict in advance the sheet length after execution of the fixing process, and perform setting such that the formation position of the toner image to be secondarily transferred to the second surface is offset from the original position on the basis of the predicted value.

Furthermore, in order to check the correctness of the above predicted value and offset setting, a known image reading device (not shown) may be arranged at the subsequent stage of the image forming apparatus 1, so that after printing on both surfaces, the printing state of the first surface and the second surface is read by the image reading device. In this case, the control part 100 determines the presence or absence of a positional shift of the image printed on the first surface and the second surface of the sheet S in the sub scanning direction from the reading result of the image reading device, and if there is a positional shift, the control part 100 corrects the set value of the offset according to the shift amount.

In the case of performing the processing of the “productivity mode” as described above, in the printing of the first surface, in consideration of errors and the like, it is necessary to provide a certain extent of space (that is, margin) in between the toner image formed on the photosensitive drum 413 and the tip end or the rear end of the sheet S. In other words, in the case of the “productivity mode”, although productivity is improved, it may be necessary to perform cutting after printing. On the other hand, in the printing of the second surface, since the control to correct the transfer position of the toner image is performed, the positions of the images to be printed on the first surface and the second surface of the sheet S can be aligned.

By adopting a configuration that can switch between the “productivity mode” and the “image quality mode”, it is possible to selectively use the finishing condition of duplex printing according to the purpose of the user or the like.

By the way, in the configuration in which the length of the sheet S is measured by detecting the passage of the tip end or the rear end of the sheet S by the conveyance sensor 54, depending on the coverage (printing rate), the sheet type, size, basis weight of the sheet S, environment (humidity) or the like, the behavior of the sheet S being conveyed changes, so that there is a possibility that an error occurs in the measured value of the length.

Here, the mode of behavior (flapping or the like) of the sheet S being conveyed can be estimated by monitoring the output signal of the conveyance sensor 54 during passage of the sheet S by the control part 100. When the output signal of the conveyance sensor 54 shows the same tendency on different sheets S, the control part 100 can regard the sheets S as having the same length.

On the other hand, from the viewpoint of minimizing the error in the measured value of the length due to the difference in behavior of the sheet S as described above, it is preferable to accumulate the above-described various types of information in the database and, at the same time, analyze the correlation with the variation of on or off of the conveyance sensor 54 under specific conditions by a method such as machine learning. By analyzing the correlation (function formula or the like), it is possible to correct the error of the measured value of the length of the sheet S to improve the measurement accuracy.

In order to improve the measurement accuracy by correcting the error of the measured value of the length of the sheet S, a well-known media sensor (for example, optical type) (not shown) for discriminating the sheet type of the sheet S may be provided on the sheet conveying path. In this case, the control part 100 applies the sheet type information of the sheet S, which is discriminated through the media sensor, to the functional expression described above to correct the error of the measured value of the length of the sheet S to be conveyed.

In the case where the sheet S is a long sheet, depending on the length of the sheet S, the case where the rear end of the sheet S is not detected yet by the conveyance sensor 54A when the tip end of the sheet S enters the secondary transfer nip.

In such a case, when the sheet S is conveyed, the control part 100 controls the conveyance of the sheet S such that the sheet S passes through the secondary transfer nip and the fixing part 60 without secondary transfer of the toner image at the secondary transfer nip, to measure the length of the sheet S using the conveyance sensor 54A or 54B. When the sheet S whose length has been measured is conveyed again to the secondary transfer nip, the control part 100 performs control such that the toner image is secondarily transferred onto the sheet S.

In one example, when the sheet S is conveyed, the control part 100 causes conveyance of the sheet Sat a predetermined speed such that the sheet S passes through the secondary transfer nip and the fixing part 60 without secondary transfer of the toner image at the secondary transfer nip, to measure the length of the sheet S using the conveyance sensor 54A. Thereafter, the control part 100 controls the conveyance of the sheet S such that the sheet S having passed through the fixing part 60 is once discharged to the outside of the apparatus. In another example, the control part 100 controls the conveyance of the sheet S such that the sheet S is conveyed to the reverse conveying path 533, and circulated in the apparatus without being switched back on the reverse conveying path 533.

Alternatively, at the time of conveyance of the sheet S, the control part 100 may not secondarily transfer the toner image at the secondary transfer nip, and measure the length of the sheet S using the conveyance sensor 54B instead of the conveyance sensor 54A. In this case, the control part 100 conveys the sheet S passed through the fixing part 60 to the reverse conveying path 533 to measure the length of the sheet S using the conveyance sensor 54B. Further, the control part 100 performs conveyance control of the sheet S such that the sheet S is returned from the joining conveying path 533c to the main conveying path 530 again such that the sheet S circulates in the inside of the apparatus without switchback conveyance in the reverse conveying path 533.

In the above embodiment, as described above with reference to FIG. 6A, the example in which the conveyance sensor 54A is arranged on the upstream side of the loop roller 53b has been described, but the arrangement of the conveyance sensor 54A is not limited to this example. However, when the arrangement of the conveyance sensor 54A changes, the content of control by the control part 100 for image transfer to the sheet S and magnification change of the toner image can be changed.

More specifically, when the distance from the conveyance sensor 54A to the secondary transfer nip is sufficiently long (longer than the length of the sheet S), both the tip end and the rear end of the sheet S are detected by the conveyance sensor 54A, and after the length of the sheet S is known, the sheet S enters the secondary transfer nip. In this case, the control part 100 can appropriately change the conveying speed of the registration roller pair 53a or the intermediate transfer belt 421 to adjust the overall magnification of the toner image transferred onto the sheet S.

On the other hand, when the distance from the conveyance sensor 54A to the secondary transfer nip is shorter than the length of the sheet S, for example, in the case where the conveyance sensor 54A is arranged between the secondary transfer nip and the registration roller pair 53a, a similar problem to that in the case of the long sheet described above occurs. That is, the rear end of the sheet S is not detected by the conveyance sensor 54A yet when the tip end of the sheet S enters the secondary transfer nip, and the timing to specify the length of the sheet S is delayed. In this case, the control part 100 performs similar control to that in the case of the long sheet, that is, control of measuring the length of the sheet S using the conveyance sensor 54A or 54B, and then secondarily transferring the toner image on the sheet S without secondary transfer of the toner image at the secondary transfer nip.

On the other hand, from the viewpoint of considering productivity to be important, the following control may be performed. That is, the control part 100 starts the processing of secondarily transferring the toner image to the sheet S that has entered the secondary transfer nip, and after the rear end of the sheet S is detected by the conveyance sensor 54A, and the length of the sheet S is specified, the control part 100 adjusts the conveying speed of the registration roller pair 53a or the intermediate transfer belt 421 so as to change the magnification in the conveying direction of the toner image transferred onto the sheet S in the middle. Such a change in magnification (variable magnification) is set to a degree of distortion that the user does not notice by visual observation. With such control, it is possible to ensure productivity of printing on sheets S of various lengths, and to reduce the size of the image forming apparatus 1.

In the embodiment described above, as a configuration example of measuring the length of the sheet S being conveyed, the length of the sheet S is measured on the basis of the timing at which the tip end and the rear end of the sheet S are detected and the information on the sheet conveying speed.

As another configuration example of measuring the length of the sheet S being conveyed, the length of the sheet S may be measured from the timing at which the tip end and the rear end of the sheet S are detected and the rotation number of a motor (not shown) that drives the conveying roller, which has been rotated during the detected time (during period from the passage of the tip end of the sheet S to the passage of the rear end).

In the above-described embodiment, the control of correcting the image formation position in the conveying direction of the toner image transferred onto the sheet S has been mainly described. In addition, in accordance with the detection result of a line sensor (arranged between the secondary transfer nip and the registration roller pair 53a) (not shown) for detecting the position of the side end portion of the sheet S, the control part 100 can perform control of appropriately correcting the image formation position in the main scanning side (width direction of the sheet) of the toner image transferred to the sheet S.

Although embodiments of the present disclosure have been described and illustrated in detail, the disclosed embodiments are made for purposes of illustration and example only and not limitation. The scope of the present invention should be interpreted by terms of the appended claims.

As used throughout this application, the words “can” and “may” are used in a permissive sense (i.e., meaning having the potential to), rather than the mandatory sense (i.e., meaning must). The words “include”, “including”, and “includes” and the like mean including, but not limited to. As used herein, the singular form of “a”, “an”, and “the” include plural references unless the context clearly dictates otherwise. As employed herein, the term “number” shall mean one or an integer greater than one (i.e., a plurality).

Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. An image forming apparatus comprising:
an image forming part that forms an image on a sheet;
a sheet conveying part that conveys the sheet to the image forming part;
a sheet length measuring part that measures a length of the sheet on the basis of a timing of a passing of a tip end and a rear end of the sheet conveyed to a sheet conveying path; and
a hardware processor that causes alignment of a formation position in a sheet conveying direction of the image between a first surface and a second surface of the sheet on the basis of a measurement result by the sheet length measuring part.

2. The image forming apparatus according to claim 1, wherein the hardware processor specifies a difference with respect to a reference value of the length of the sheet from a measurement result by the sheet length measuring part, and changes the formation position of the image formed on the sheet according to the difference.

3. The image forming apparatus according to claim 2, wherein the sheet length measuring part includes an end portion detection sensor that detects the tip end and the rear end of the sheet in the conveying direction, and
wherein the hardware processor specifies the difference of the sheet from detection timings of the tip end and the rear end of the sheet detected by the end portion detection sensor and from conveying speed information of the sheet.

4. The image forming apparatus according to claim 1, wherein the hardware processor controls the sheet conveying part or the image forming part so as to align the formation position of the image between the first surface and the second surface of the sheet.

5. The image forming apparatus according to claim 1, wherein the sheet conveying part includes:
a main conveying path in which the sheet fed from a sheet feeding part is conveyed to the image forming part; and
a duplex conveying path that is branched from a conveying direction downstream side of the image forming part in the main conveying path, and in which the conveying direction of the sheet is reversed at a switchback point so that front and back of the sheet are reversed and the sheet is conveyed to an upstream side of the image forming part.

6. The image forming apparatus according to claim 5, wherein:
the sheet length measuring part includes end portion detection sensors that detect the tip end and the rear end of the sheet in the conveying direction,
the end portion detection sensors are provided in the main conveying path and the duplex conveying path, respectively, and
the hardware processor corrects the formation position of the image printed on the second surface of the sheet according to a measurement result of each of the end portion detection sensors when a duplex printing job is performed.

7. The image forming apparatus according to claim 5, wherein:
the sheet length measuring part includes end portion detection sensors that detect the tip end and the rear end of the sheet in the conveying direction,
the end portion detection sensors are provided in the main conveying path and the duplex conveying path, respectively, and
when a duplex printing job is performed, the hardware processor corrects the formation position of the image printed on the first surface of the sheet according to a measurement result by the end portion detection sensor provided in the main conveying path, and corrects the formation position of the image printed on the second surface of the sheet according to a correction amount of the formation position and a measurement result by the end portion detection sensor provided in the duplex conveying path.

8. The image forming apparatus according to claim 5, wherein:
the sheet length measuring part includes end portion detection sensors that detect the tip end and the rear end of the sheet in the conveying direction,
the end portion detection sensors are provided in the main conveying path and the duplex conveying path, respectively, and
when a duplex printing job is performed, according to an instruction by a user, the hardware processor performs any of:
first control of correcting the formation position of the image printed on the second surface of the sheet according to a measurement result by each of the end portion detection sensors; and
second control of correcting the formation position of the image printed on the first surface of the sheet according to a measurement result by the end portion detection sensor provided in the main conveying path, and correcting the formation position of the image printed on the second surface of the sheet according to a correction amount of the formation position and a measurement result by the end portion detection sensor provided in the duplex conveying path.

9. The image forming apparatus according to claim 1, wherein the hardware processor performs control such that a rear end position in the sheet conveying direction of the image formed on the first surface of the sheet coincides with a tip end position in the sheet conveying direction of the image formed on the second surface of the sheet.

10. The image forming apparatus according to claim 9, wherein the hardware processor performs control such that a center position in the sheet conveying direction of the image formed on the first surface of the sheet coincides with a center position in the sheet conveying direction of the image formed on the second surface of the sheet.

11. The image forming apparatus according to claim 9, wherein the hardware processor changes magnification in the sheet conveying direction of the image formed on an image carrier of the image forming part such that the rear end position and a tip end position in the sheet conveying direction of the image formed on the first surface of the sheet coincides with the tip end position and a rear end position in the sheet conveying direction of the image formed on the second surface of the sheet.

12. The image forming apparatus according to claim 1, wherein the sheet is a long sheet, the long sheet being longer in a conveying direction than a sheet of A4 size or a sheet of A3 size.

13. An image forming control method implemented in an image forming apparatus, the image forming apparatus including an image forming part that forms an image on a sheet, and a sheet conveying part that conveys the sheet to the image forming part, the image forming control method comprising:
measuring a length of the sheet on the basis of a timing of a passing of a tip end and a rear end of the sheet being conveyed; and
aligning a formation position in a sheet conveying direction of the image between a first surface and a second surface of the sheet on the basis of a measurement result.
